(19) United States
(12) Patent Application Publication
(10) Pub. No.: US 2010/0288137 A1
(43) Pub. Date: Nov. 18, 2010

(54) TYPE OF GRILL

(75) Inventor: Yixin ZHAN, Fujian Province (CN)

Correspondence Address: RABIN & Berdo, PC, 1101 14TH STREET, NW, SUITE 500, WASHINGTON, DC, 20005, US

(73) Assignee: Tsann Kuen (Zhangzhou) Enterprise Co., Ltd., Fujian Province (CN)

(21) Appl. No.: 12/780,353

(22) Filed: May 14, 2010

(30) Foreign Application Priority Data
May 14, 2009 (CN) 200920138420.0

(51) Int. Cl. A47J 37/06

(52) U.S. Cl. 99/372

(57) ABSTRACT

A type of grill in the present invention relates to a household cooking appliance. The grill in the present invention comprises an upper cover, a grilling pan, a heating pan, a hinge, a base and a stepped unit disposed on the left inside and right inside of said base respectively; upper cover, grilling pan, heating pan and hinge remain kept in the grill; The presented grill omits the back wall and the bottom wall of the base and simplifies the structure without reducing any grilling function.

### FIELD OF THE INVENTION

The present invention relates to a household cooking utensil.

### BACKGROUND OF THE INVENTION

Referring to FIG. 1 and FIG. 2, the conventional grill comprises an upper cover 1, a grilling pan 2, a heating pan 3, a hinge 4 and a base 5. The upper cover 1 is connected to the back of the heating pan 3 by the hinge 4. By holding the handle 11 on the front part of the upper cover 1, user can make the upper cover 1 to rotate around the heating pan 3 in order to open or close the grill. The grilling pan 2 is detachably disposed on the heating pan 3. The base 5 is in the shape of a box, two strip supporting leg are disposed under the bottom wall 51. The heating pan 3 is disposed on the opening of the base 5. The structure of the conventional grill needs to be simplified.

### SUMMARY OF THE INVENTION

The present invention provides a type of grill, which also has the function of the conventional grill, and the structure of the present invention is simplified.

The technical solution applied by the present invention is:

A grill comprises an upper cover, a grilling pan, a heating pan, a hinge, a base, and a stepped unit disposed on the left inside and right inside of said base respectively; wherein the rear side of the base and the bottom of the base are in open, and said stepped unit supporting said heating pans respectively; upper cover, grilling pan, heating pan and hinge remain kept in the grill; The presented grill omits the back wall and the bottom wall of the base and simplifies the structure without reducing any grilling function.

Tabular supporting legs, which extend downwards, are disposed respectively on the front, the left and the right of said base. Therefore the distance between the heating pan and the platform supporting the grill is increased, and the structure of the grill is simplified.

Said heating pan comprises a box for receiving the power cord and a detachable box cover for sealing said box. The box is used to store power lines in order to facilitate storing the grill.

The distances between said heating pan and horizontal plane are over than 28 mm.

The present invention doesn't need insulating board (bottom wall) between the heating pan and the platform supporting the grill; if the conventional grill doesn't have insulating board, the heat from the heating pan will broke the platform supporting the grill. Without the back wall and the bottom wall of the base, in the present invention the distance between the heating pan and the platform supporting the grill is over 28 mm, and after test, the temperature of the surface of the platform can be controlled lower than 65 degrees, confirming to GB4706.1-2005/IEC 60335-1:2004. Especially when an upper heating pan and an upper grilling pan are disposed in the grill, the lower heating is exposed and the temperature of it can be lowered. Although the time of grilling food is extended, the grilled food becomes more delicious.

### BRIEF DESCRIPTION OF THE DRAWINGS

FIG. 1 is a structure view of the conventional grill when opening.

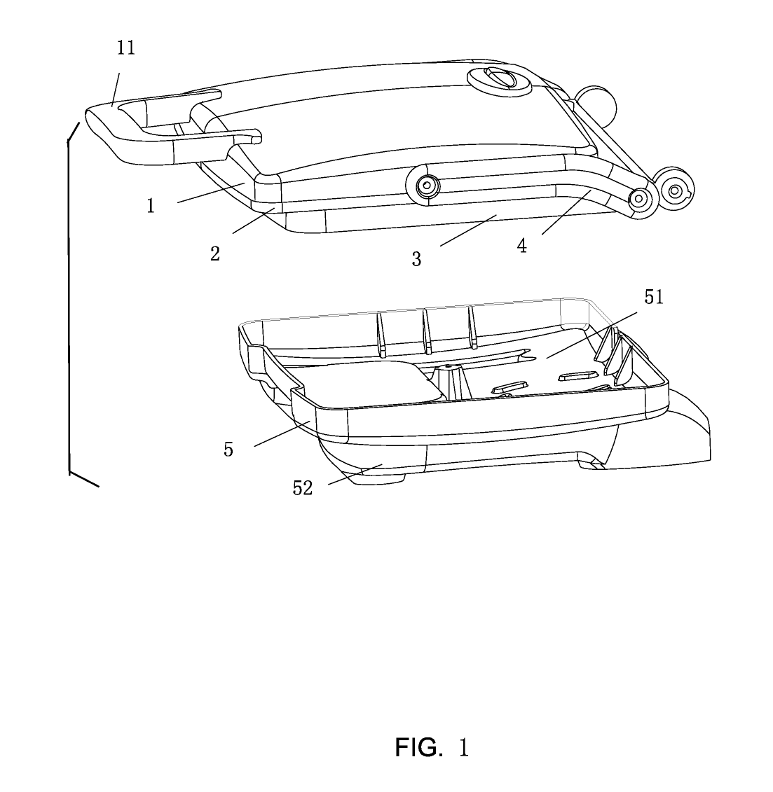

FIG. 2 is a top view of the conventional grill in FIG. 1.

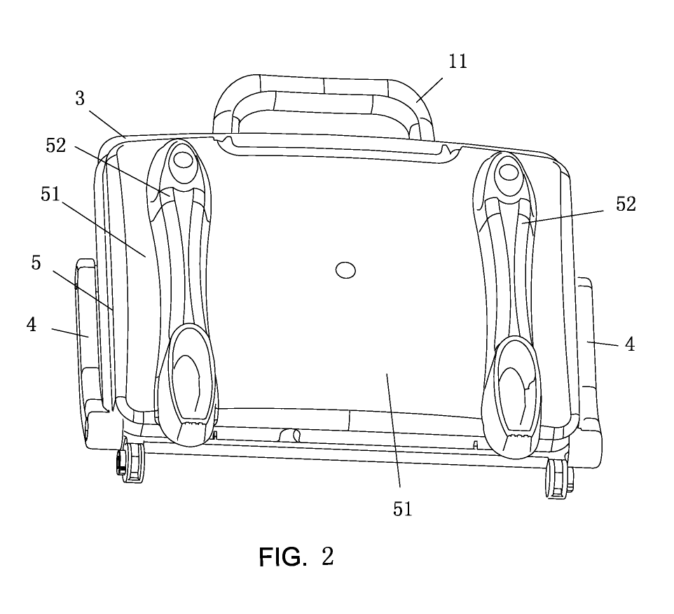

FIG. 3 is a three-dimension view of the grill of the present invention in a preferred embodiment.

FIG. 4 is a structure view of the grill of a preferred embodiment in FIG. 3, when it is opening.

FIG. 5 is a top view of the grill of a preferred embodiment in FIG. 3.

### DESCRIPTION OF SPECIFIC EMBODIMENTS

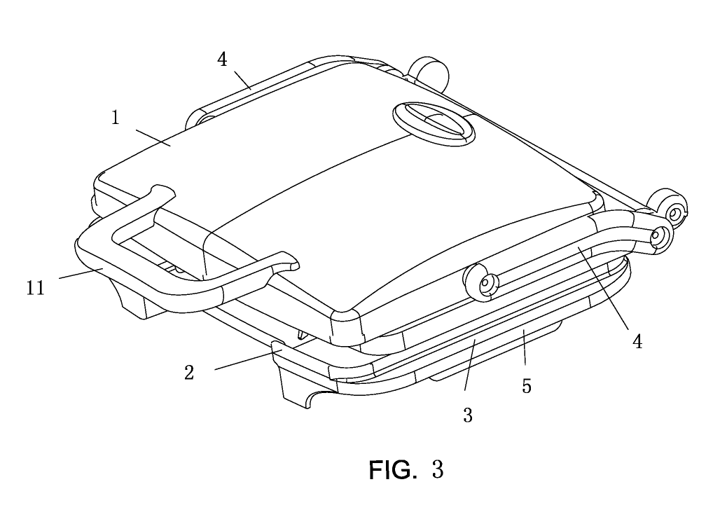

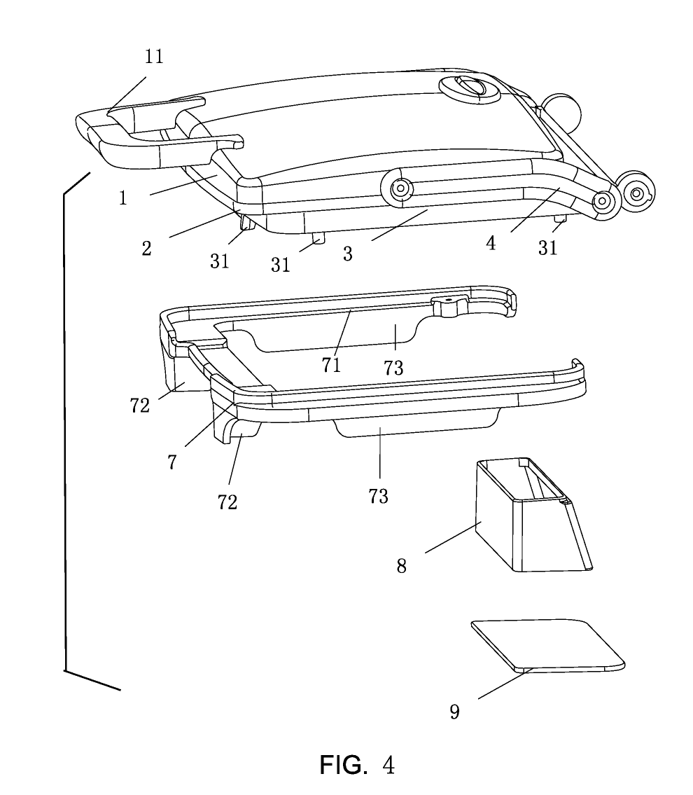

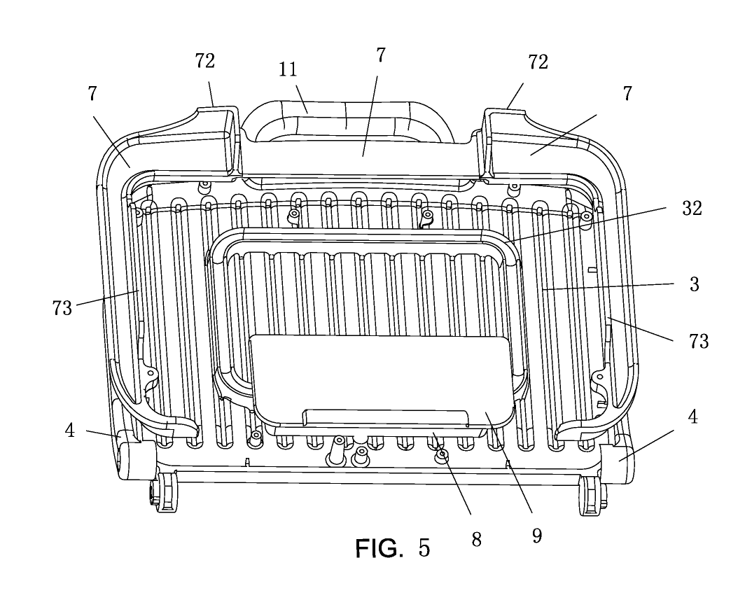

Referring to FIG. 3 to 5, the grill of the present invention in a preferred embodiment comprises an upper cover 1, a grilling pan 2, a heating pan 3, a hinge 4, a base 7, a power box 8 and a power box cover 9.

The upper cover 1 is a box which is opening downward and a handle 11 is disposed on the front part of the upper cover 1. The upper cover 1 is connected to the back of the heating pan 3 by the hinge 4. By holding the handle 11 on the front part of the upper cover 1, users can make the upper cover 1 to rotate around the heating pan 3 in order to open or close the grill. The grilling pan 2 is detachably disposed on the heating pan 3. The base 7 is in the shape of “Π”, whose rear side is opening, and stepped unit 71 is disposed on the left inside and the right inside of the base 7 respectively. Several feet 31 on the periphery of the lower surface are respectively supporting the stepped unit 71. Supporting legs 72 which are extending downward are disposed on the front part of the base 7; Supporting legs 73 which are extending downward are respectively disposed on the left side and the right side of the base 7. A power box 8 is disposed under the heating pan 3. A power box cover 9 is detachably disposed to seal the power box 8. See from the bottom of the grill, the electric heating tube 32 disposed on the lower surface of heating pan 3 is exposed. The distance between the heating pan and horizontal plane is over than 28 mm.

All above is just a preferred embodiment of the present invention, so the present invention should not be limited in these embodiments. In a word, it should be understood that according to the scope of the present invention and the content of the description, all the various equivalent modifications and alterations will be apparent in the scope and spirit of this invention. Therefore, the scope and sprit of the invention is limited only by the claims.

What is claimed is:

1. A grill comprises an upper cover, a grilling pan, a heating pan, a hinge, a base, and a stepped unit disposed on the left inside and right inside of said base respectively; wherein the rear side of the base and the bottom of the base are in open, and said stepped unit supporting said heating pans respectively.

2. The grill according to claim 1, wherein tabular supporting legs, which extend downwards, are disposed respectively on the front, the left and the right of said base.

3. The type of grill according to claim 1, wherein said heating pan comprises a box for receiving the power cord and a detachable box cover for sealing said box.

4. The grill to according claim 1, wherein the distances between said heating pan and horizontal plane are over than 28 mm.
